(19) United States
(12) Patent Application Publication
(10) Pub. No.: US 2016/0114507 A1
(43) Pub. Date: Apr. 28, 2016

(54) INJECTION MOLDING SYSTEM

(71) Applicant: FANUC Corporation, Yamanashi (JP)

(72) Inventors: Tatsuhiro UCHIYAMA, Yamanashi (JP); Naoaki SEKI, Yamanashi (JP); Toshio ISHIKURO, Yamanashi (JP)

(21) Appl. No.: 14/919,172

(22) Filed: Oct. 21, 2015

(30) Foreign Application Priority Data
Oct. 22, 2014 (JP) 2014-215544

(51) Int. Cl. B29C 45/40

(52) U.S. Cl. CPC B29C 45/4005

(57) ABSTRACT

An injection molding system includes a cavity moving unit configured to move the movable side mold, for positioning at least one cavity selected arbitrarily in fillable position such that resin injected is configured to fill the cavity in fillable position when the molds are closed and at least one cavity, different from the cavity in the fillable position, in ejectable position such that a molded item in the ejectable position is configured to be taken out when the molds are closed, and a molded item ejection unit configured to eject the molded item in the cavity positioned in the ejectable position when the molds are closed.

### BACKGROUND OF THE INVENTION

1. Field of the Invention

The present invention relates to an injection molding system, and more particularly to an injection molding system which moves cavity of the mold at each molding cycle for molding.

2. Description of the Related Art

The present invention relates to an injection molding system, and more particularly to an injection molding system which moves cavity of the mold at each molding cycle for molding.

An injection molding machine manufactures a molded item by process in which molds are closed and mold clamping force is generated, process in which molten resin is injected in the cavity in the molds, process in which a molded item in the cavity is cooled while resin is melt and measured as preparation for the next molding cycle, process in which the molds are opened, process in which a completed molded item is ejected from the molds. Furthermore, when a molded item integrated to an insertion component is manufactured, called insert molding, process in which the insertion component is inserted in the cavity of the mold is added after the process in which the molded item is ejected from the molds.

As a method for enhancing productivity in the injection molding machine which manufactures the molded item by the molding cycle described above, a method in which time duration of each process is reduced is known. More specifically, a method of enhancing drive unit capacity such as increasing rotation number of a servo motor engaged in opening and closing of the mold in order to reduce time for closing and opening the molds, a method of enhancing cooling unit capacity for cooling the mold in order to reduce cooling time of the molded item, and the like are known. As another method, a method in which time for entire molding cycle is reduced by overlapping each process is known. More specifically, a method in which injection is performed before predetermined mold clamping force is generated, a method in which the molds are opened when the cooling of the molded item is completed before the end of the measurement process, and the like are known. In Japanese Patent Laid-Open No. 2008-179008, a technique in which molding cycle time is reduced by making rotation operation of the rotary table with the other operation in an injection molding device using a rotary table.

Generally, process for ejecting a molded item from the molds and process for inserting an insertion component in the mold are performed by inserting a molded item ejection device or a robot between a movable mold and a stationary mold.

For using the devices, it is necessary to insert the devices between the movable mold and the stationary mold. The process for closing the molds need to be performed after the evacuation of the device, to avoid the problem in which the molds interferes with the devices or the devices are sandwiched between the molds. Though increase of moving velocity of motion of the molded item ejection device or the robot is considered, the increase of the velocity is limited, and it is difficult to reduce the cycle time beyond the capacity of the devices.

### SUMMARY OF THE INVENTION

In view of the above-described problems in the prior art techniques, a purpose of the present invention is to reduce the molding cycle time in the molding system configured to perform molding by moving a cavity of the mold at each molding cycle, compared to the case where only one cavity is used.

The injection molding system according to the present invention includes molds composed of a fixed side mold and a movable side mold including a plurality of cavities, a mold opening/closing unit configured to open and close the mold, a cavity moving unit configured to move the movable side mold, for positioning at least one arbitrarily selected cavity in fillable position such that resin injected is configured to fill the cavity in fillable position when the molds are closed and at least one cavity, different from the cavity in the fillable position, in ejectable position such that a molded item in the ejectable position is configured to be ejected when the molds are closed, and a molded item ejection unit configured to eject the molded item in the cavity positioned in the ejection position when the molds are closed.

The injection molding system may further include a component insertion unit configured to insert a component in a cavity in the ejection position.

The injection molding system may further include an injection condition storing unit configured to store injection condition in association with the plurality of cavities, wherein the injection molding system is configured to read out the injection condition corresponding to the cavity positioned in the fillable position from the injection condition storing unit and inject a molten resin in accordance with the injection condition read out.

The molding ejection unit may be a robot.

The present invention, with the configuration described above, provides an injection molding system which can reduce the molding cycle time in the molding system configured to perform molding by moving a cavity of the mold at each molding cycle, compared to the case where only one cavity is used.

### BRIEF DESCRIPTION OF THE DRAWINGS

The above-described object, the other object, and the feature of the invention will be proved from the description of embodiments below with reference to the accompanying drawings. In these drawings:

FIG. 1 shows a configuration diagram of the injection molding system composed of an injection molding device and molds according to the present invention.

FIG. 2 is a configuration diagram of the mold.

FIG. 3 is a diagram for explaining operation order of molding cycle in the injection molding system with two cavities according to the present invention.

### DETAILED DESCRIPTION OF THE PREFERRED EMBODIMENTS

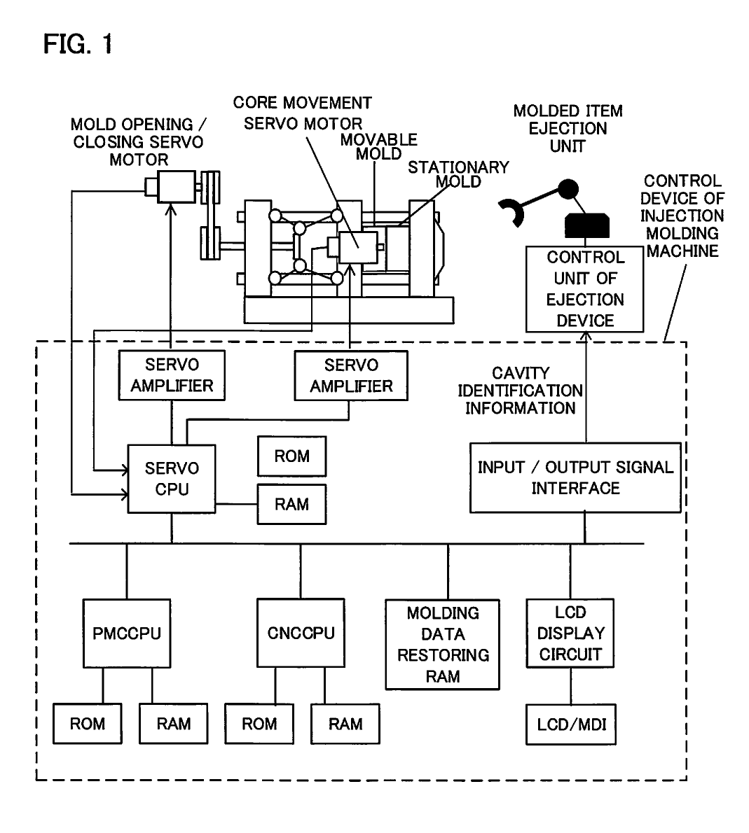

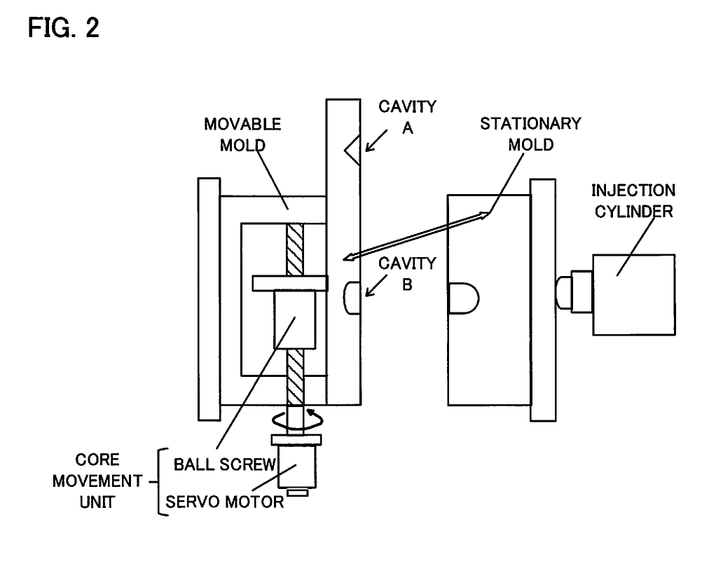

FIG. 1 shows a configuration diagram of the injection molding system composed of an injection molding device and molds according to the present invention. FIG. 2 is a configuration diagram of the mold. A plurality of cavities are formed on a movable core in the mold, and entire cavities are configured to be moved by a core movement unit.

In the present embodiment, preferably, the core movement unit may be composed of a ball screw and a rotation type servo motor. Alternatively a linear motor or the like may be used.

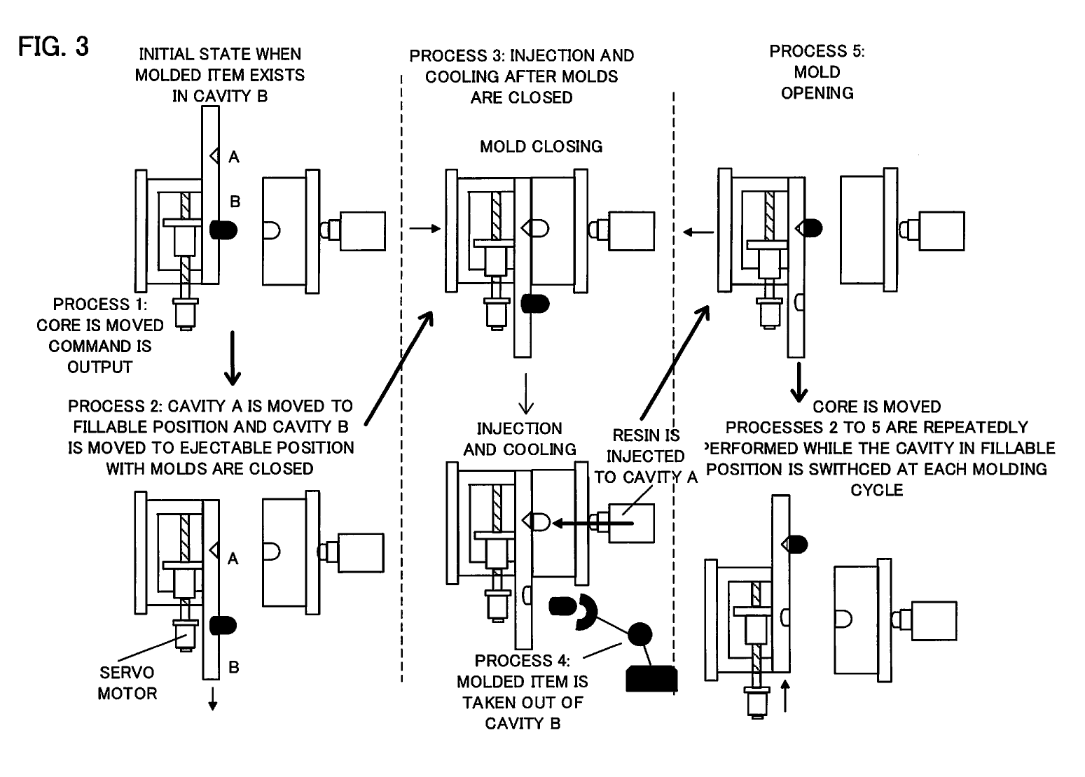

Operation order of molding cycle in the injection molding system with two cavities according to the present invention will be explained using FIG. 3. The operation order is as follows.

In process 1, a control device of the injection molding device output movement command for a cavity A of the two cavities, in which a molded item has not molded yet, to fillable position and for a cavity B of the two cavities, in which a molded item has been already molded, to ejectable position, to a core movement servo motor. It should be noted that, the control device of the molding device may include a unit to select or designate a cavity to be moved to the fillable position and the movement command may make the cavity movement unit move the selected cavity move to the fillable position. In this case, the control device of the injection molding device outputs signal for designating a cavity to be moved to the fillable position to the cavity movement unit. Alternatively, a molded item ejection unit or a robot to be described below may include a unit to select or designate a cavity to be moved to the fillable position and notice the selected cavity to the injection molding device and the cavity movement unit, such that the cavity movement unit moves the cavity to the fillable position.

In process 2, the cavity A is placed in the fillable position and the cavity B is placed in the ejectable position when core movement is completed

In process 3, the molds are closed, resin is filled in the cavity A, then the molded item is cooled.

It should be noted that “injection” in the description of the present invention includes operation for injecting molten resin to the cavity of the mold in addition to pressure keeping operation for applying pressure to the injected resin.

In process 4, the molded item ejection unit or a robot takes out the molded item while the molds are closed in process 3. Molding cycle time can be reduced since ejection operation of the molded item is performed during injection or cooling without wasting time.

The control device of the injection molding device notify the molded item ejection unit or the robot of cavity identification information for discriminating that each cavity is in the fillable position or in the ejectable position. The molded item ejection unit and the robot store ejectable position of the molded item for each cavity identification information. Thus it becomes possible for the molded item ejection unit and the robot to take out the molded item corresponding to moved position, when the cavity is moved by the core movement unit. The identification information of the cavity placed at the ejectable position may be sent to the molded item ejection unit and the robot by output of electric signal of a relay or the like, or by a communication unit.

Two cavities are supposed to be a cavity A and a cavity B, for example. The control unit of the injection molding device notifies the molded item ejection unit and the robot that the cavity A is moved to the fillable position, that the cavity B is moved to the ejectable position, or the both, when the cavity to be filled with resin is the cavity A. The molded item ejection unit and the robot stores the molded item ejectable position of each of cavities A and B in advance. Thus the molded item in the cavity B can be ejected in the molded item ejectable position of the cavity B when the cavity A is placed in the fillable position, while the molded item in the cavity A can be ejected in the molded item ejectable position of the cavity A when the cavity B is placed in the fillable position.

In process 5, the molds are opened after the process of ejection of the molded item from the cavity and cooling is completed, then the cavity placed in the ejectable position is moved to the fillable position, and the process returns to process 3. Accordingly, processes 2 to 5 are repeatedly performed while the cavity is switched at each molding cycle. In the process for opening the molds, it is not necessary for the molded item ejection unit and the robot to be inserted between the movable mold and the stationary mold. Therefore, opening amount of the molds can be made to be small such that the core and the molded item is movable, and the molding cycle time is reduced.

In the explanation above, only the ejection of the molded item is performed during performance of the process 3. However, when the insertion molding is performed, operation in which the molded item ejection unit or the robot inserts the insertion component to the cavity may be performed in the process. The ejection of the molded item and the insertion of the insertion item may be performed separately or sequentially during the performance of the process 3.

When the configuration of the plurality of cavities is different from each other, different injection conditions are necessary for each cavity. In the case, the injection condition for each cavity may be stored in the control device of the injection molding device, and the molding condition corresponding to the cavity moved to the fillable position is read out from the control device of the injection molding device when any one of the cavities moves to the fillable position in the process 2, and the injection may be performed according to the read out injection condition in the process 3.

1. An injection molding system comprising:
molds composed of a fixed side mold and a movable side mold including a plurality of cavities;
a mold opening/closing unit configured to open and close the mold;
a cavity moving unit configured to move the movable side mold, for positioning at least one arbitrarily selected cavity in fillable position such that resin injected is configured to fill the cavity in fillable position when the molds are closed and at least one cavity, different from the cavity in the fillable position, in ejectable position such that a molded item in the ejectable position is configured to be ejected when the molds are closed;
a molded item ejection unit configured to eject the molded item in the cavity positioned in the ejection position when the molds are closed.

2. An injection molding system according to claim 1 comprising:
a component insertion unit configured to insert a component in a cavity in the ejection position.

3. An injection molding system according to claim 1 comprising:
an injection condition storing unit configured to store injection condition in association with the plurality of cavities; wherein
the injection molding system is configured to read out the injection condition corresponding to the cavity positioned in the fillable position from the injection condition storing unit and inject a molten resin in accordance with the injection condition read out.

4. An injection molding system according to claim 1 wherein the molding ejection unit is a robot.
